(19) United States
(12) Patent Application Publication
(10) Pub. No.: US 2015/0101127 A1
(43) Pub. Date: Apr. 16, 2015

(54) MATTRESS CORE AND COVER ASSEMBLY

(71) Applicant: L&P Property Management Company, South Gate, CA (US)

(72) Inventor: David K. Winton, Jasper, MO (US)

(73) Assignee: L&P Property Management Company, South Gate, CA (US)

(21) Appl. No.: 14/054,218

(22) Filed: Oct. 15, 2013

(51) Int. Cl. A47C 27/06; A47C 27/14; B68G 7/05; A47C 27/00

(52) U.S. Cl. CPC A47C 27/063; A47C 27/002; A47C 27/14; B68G 7/051
USPC 5/720; 5/737; 29/91.1

(57) ABSTRACT

A cover for providing the appearance of multiple segments in an underlying core structure having a slit extending around the periphery of the core structure is provided. The cover comprises a top panel configured to cover an upper surface of the core structure, a bottom panel configured to cover a lower surface of the core structure, a border connecting the top panel with the bottom panel and configured to cover the sidewalls of the core structure, and a tucking element coupled with the border and configured to be received in the slit of the core structure. The portion of the border between the tucking element and the top panel appears to be a first segment of the core structure and the portion of the border between the tucking element and the bottom panel appears to be a second segment of the core structure.

### RELATED APPLICATIONS

N/A

### FIELD OF THE INVENTION

This invention relates generally to bedding, and more particularly to mattresses and covers therefore.

### BACKGROUND OF THE INVENTION

In the bedding and related arts, so-called pillow-top mattresses are popular products. This type of mattress typically includes at least one layer of padding located on top of a traditional mattress structure, such as an innerspring core. The construction of pillow-top mattresses gives them a distinctive appearance that is recognizable by customers. In particular, pillow-top mattresses have two identifiable segments: a top segment associated with the padding layer, and a bottom segment associated with the traditional mattress structure. The top segment is typically smaller (in the height dimension) than the bottom segment, and this size relationship between the two segments is also an identifiable feature of pillow-top mattresses. Pillow-top mattresses are also sometimes referred to as euro-top, box-top, or ultra-cushion mattresses.

Foam mattresses are another popular type of mattress product. Foam mattresses can be monolithic foam structures, or can include a foam-encased spring unit.

It would be desirable if the aesthetic features characteristic of pillow-top mattresses could be incorporated into foam mattresses, for example, zipper constructed foam mattresses.

Accordingly, a improved mattress and cover assembly that attains these goals is desirable.

### SUMMARY OF THE INVENTION

In one aspect, a cover for providing the appearance of multiple segments in an underlying core structure having a slit extending around the periphery of the core structure is provided. The cover comprises a top panel configured to cover an upper surface of the core structure, a bottom panel configured to cover a lower surface of the core structure, a border connecting the top panel with the bottom panel and configured to cover the sidewalls of the core structure, and a tucking element coupled with the border and configured to be received in the slit of the core structure. The portion of the border between the tucking element and the top panel appears to be a first segment of the core structure and the portion of the border between the tucking element and the bottom panel appears to be a second segment of the core structure.

The tucking element can include a cord, for example elastic cord or draw-cord. The tucking element can further include a rigid band. The top panel can be connected with the border by a binding joint. The top panel can include a plurality of layers.

In another aspect, a method for covering a core structure with a cover to create the appearance of multiple segments in the core structure is provided. The method comprises positioning a top panel of the cover adjacent an upper surface of the core structure, positioning a border of the cover adjacent the sidewalls of the core structure, inserting a tucking element coupled with the border into a slit extending around the periphery of the core structure, and positioning a bottom panel of the cover adjacent a lower surface of the core structure. The portion of the border between the tucking element and the top panel appears to be a first segment of the core structure and the portion of the border between the tucking element and the bottom panel appears to be a second segment of the core structure.

The tucking element can include a cord, and the method can further comprise moving the cord into the slit toward the interior of the core structure. The cord can be a draw-cord, and the step of moving the cord can include tightening the draw-cord. The cord can include an elastic cord, and the step of moving the cord can include allowing the elastic cord to retract. The method can further comprise closing the cover. The step of closing the cover can include closing a zipper of the cover. The method can further comprise creating the slit in the core structure. The step of creating the slit can include cutting the core structure. The step of creating the slit can include forming the core structure by combining a first component and a second component so as to define the slit between the first component and the second component.

In yet another aspect, an assembly is provided. The assembly comprises a core structure having an upper surface, a lower surface, sidewalls between the upper surface and the lower surface, and a slit extending in the sidewalls around the periphery of the core structure, and a cover covering the core structure, the cover including a top panel covering the upper surface, a bottom panel covering the lower surface, a border connecting the top panel with the bottom panel and covering the sidewalls, and a tucking element received in the slit. The portion of the border between the tucking element and the top panel appears to be a first segment of the core structure and the portion of the border between the tucking element and the bottom panel appears to be a second segment of the core structure.

The core structure can be a solid foam core or a foam-encased inner spring core.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is an exploded perspective view of one type of mattress core according to the principles of the present invention.

FIG. 2 is a disassembled perspective view of the mattress core of FIG. 1 with a cover according to the principles of the present invention.

FIGS. 3-6 are cross-sectional views of an edge of the mattress core and cover of FIGS. 1 and 2 illustrating the steps of assembling the mattress core and cover.

FIG. 7 is a perspective view of the assembled mattress core and cover assembly of FIGS. 1-6.

FIG. 8 is a perspective view of another type of mattress core according to the principles of the present invention.

FIG. 9 is a perspective view of the cover of the present invention usable with the mattress core of FIG. 8.

FIG. 10 is a disassembled perspective view of the mattress core and cover of FIGS. 8 and 9.

FIGS. 11-14 are cross-sectional views of an edge of the mattress core and cover of FIGS. 8-10 illustrating the steps of assembling the mattress core and cover.

FIG. 15 is a perspective view of the assembled mattress core and cover assembly of FIGS. 8-14.

### DETAILED DESCRIPTION OF THE INVENTION

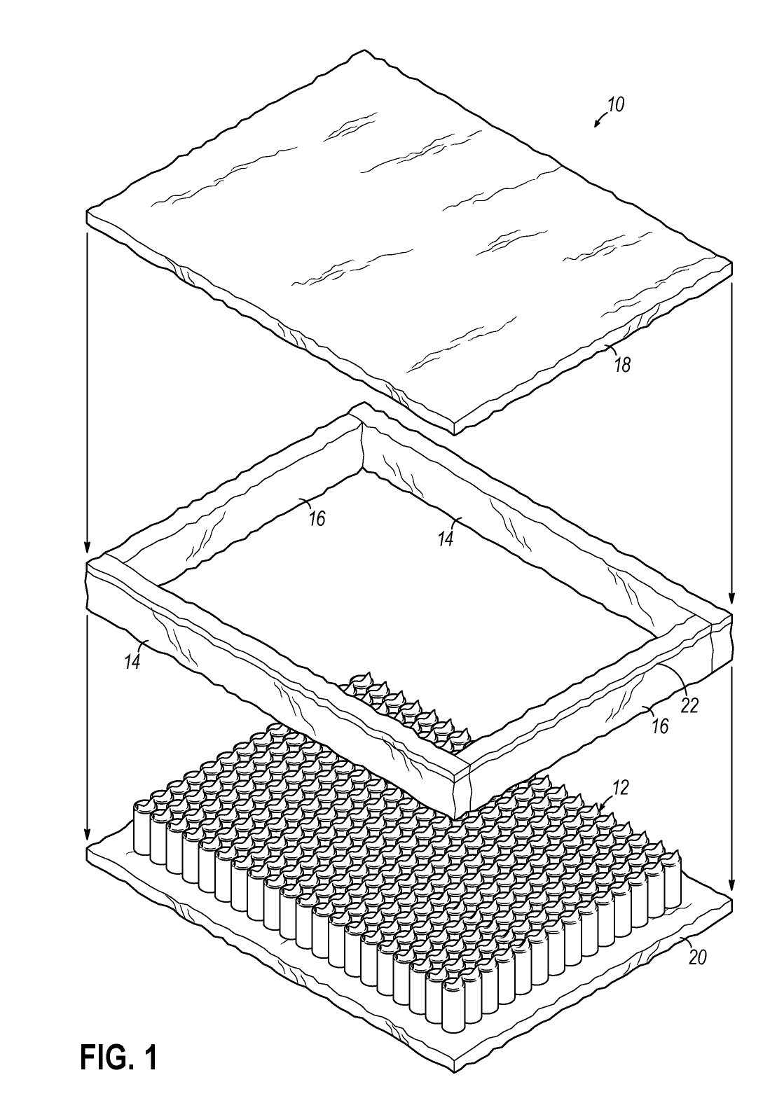

Referring first to FIG. 1, there is illustrated a mattress core 10 according to the principles of the invention. The mattress core 10 comprises a spring core assembly 12 encased within foam side panels 14, 14 and foam end panels 16, 16. The spring core 12, side panels 14, 14, and end panels 16, 16 are covered by a top foam panel 18 and by a bottom foam panel 20. The side panels 14, 14 and end panels 16, 16 include a slit 22 extending around a periphery thereof for purposes to be described below. The assembly of spring core 12, side panels 14, 14, end panels 16, 16, top panel 18, and bottom panel 20 is encased within a covering, to be described below, in order to complete the mattress. While the invention is illustrated herein as incorporated into a mattress, it could just as well be incorporated into, and the invention is equally applicable to, seating products.

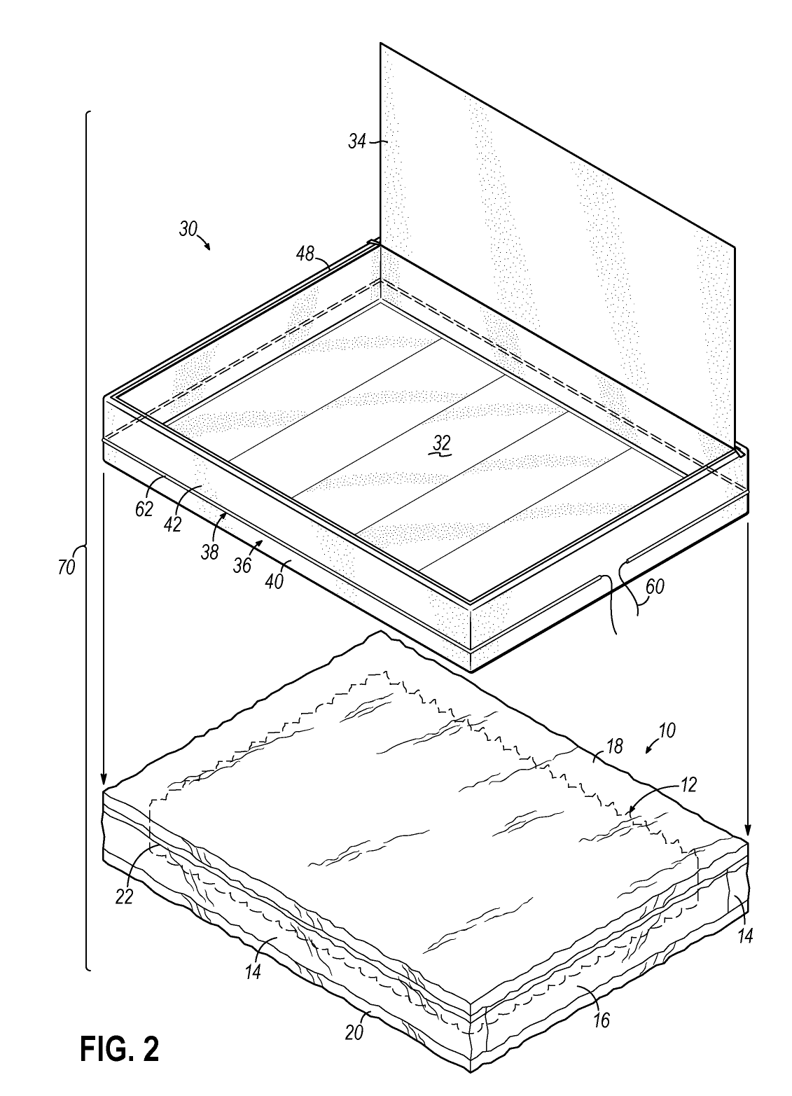

Referring now to FIG. 2, the mattress core 10 is shown assembled and ready for encasement in a cover 30 according to the principles of the present invention. Cover 30 includes a top panel 32, a bottom panel 34, and a border panel or simply border 36 extending around an entire periphery of the cover 30. A tucking element 38 is secured to the border 36, and divides the border 36 into a first or upper segment 40 and a second or lower segment 42. The tucking element 38 can take the form of a cord, for example elastic cord or draw-cord. In the case of the cover 30 being a one-piece zippered cover, the bottom panel 34 and border 36 can include a zipper 48 for zipping the bottom panel 34 closed. However, a zippered construction is not required. The mattress may be constructed using a conventional tape-edge process. Binding tape may be used to close the mattress cover, utilizing a tape-edge machine, or similar equipment.

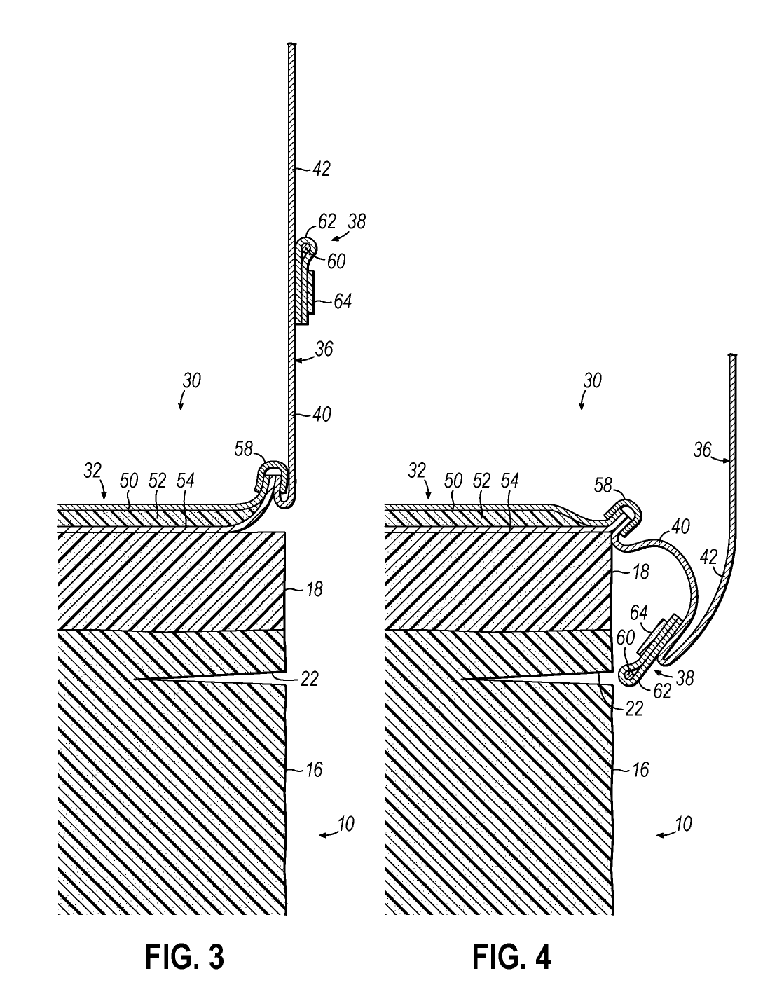

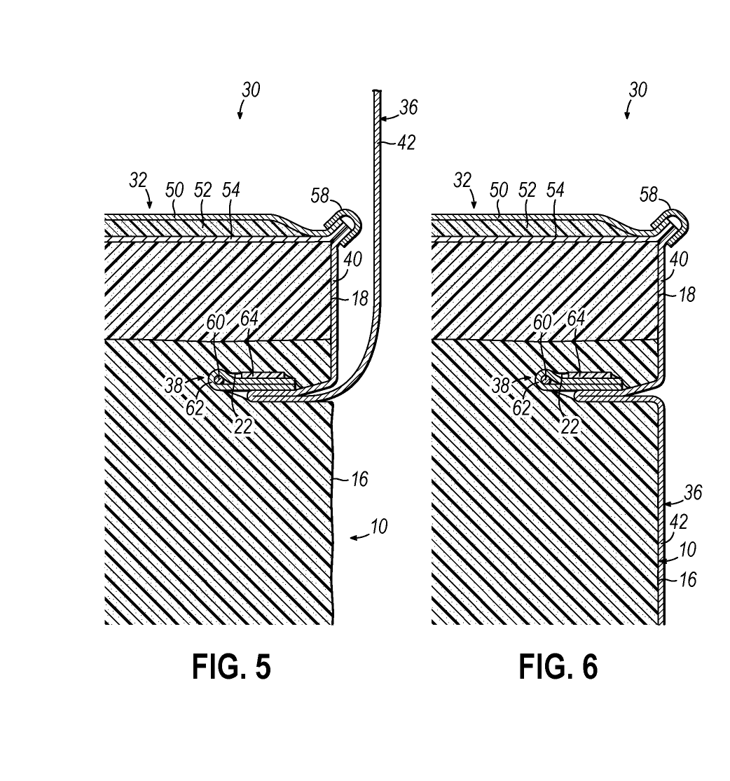

Referring now to FIGS. 3-6, additional details of the cover 30 are seen as well as the steps of assembling the mattress core 10 and cover 30. For example, top panel 32 of cover 30 can comprise an outer layer 50, a filler layer 52, and an inner layer 54, and can be attached to the border 36 with a binding joint 58. The tucking element 38 can comprise a draw-cord 60, contained within a sleeve 62 which is sewn to border 36. Optionally a rigid or semi-rigid band or strap 64, for example plastic strip, can be sewn to border 36 above or below draw-cord 38 for additional reinforcement.

To assemble the cover 30 onto the mattress core 10, the cover 30 is first inverted from the position shown in FIG. 2 and then turned inside out as is illustrated in FIGS. 3-6. The cover 30 is wrapped over the top of the mattress core 10 and the draw-cord 38 is tucked into the slit 22. The draw-cord 38 is then tightened pulling the material of the cover 30 into the slit 22. Then, the cover 30 is pulled down over the rest of the mattress core 10. Finally, the bottom panel 34 is secured to the border 36 by zipping the zipper 48 closed, thereby forming the mattress core and cover assembly 70.

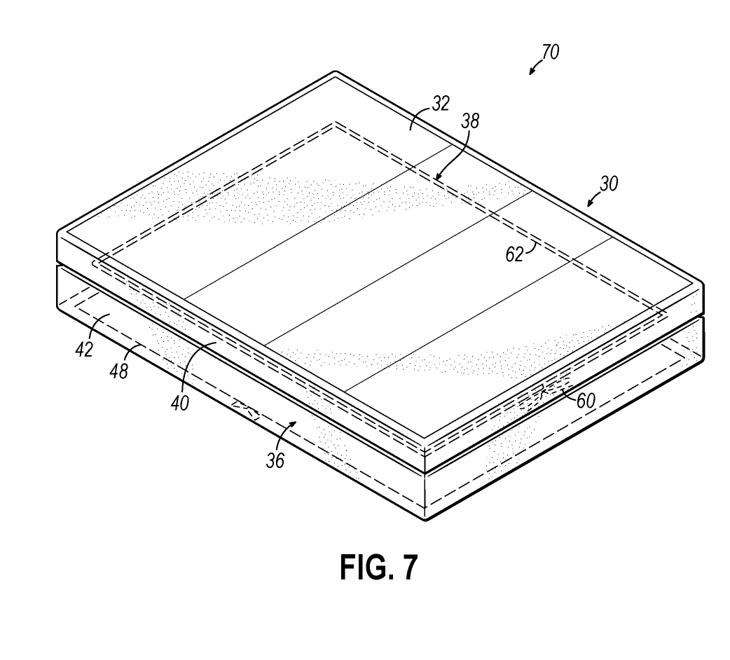

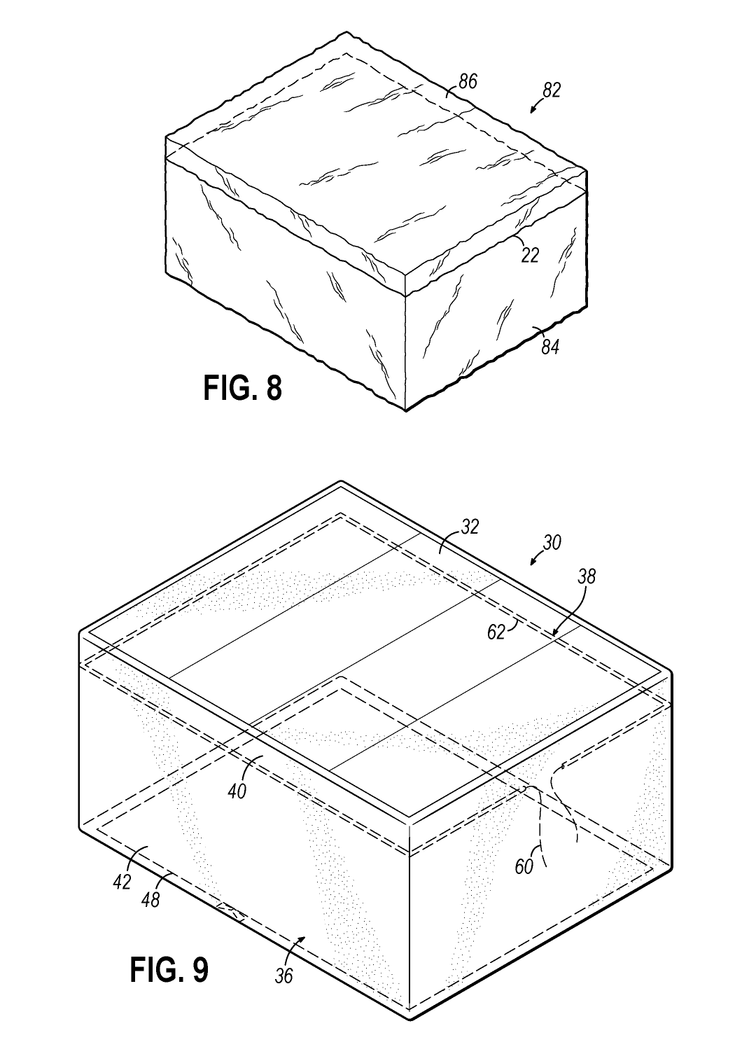

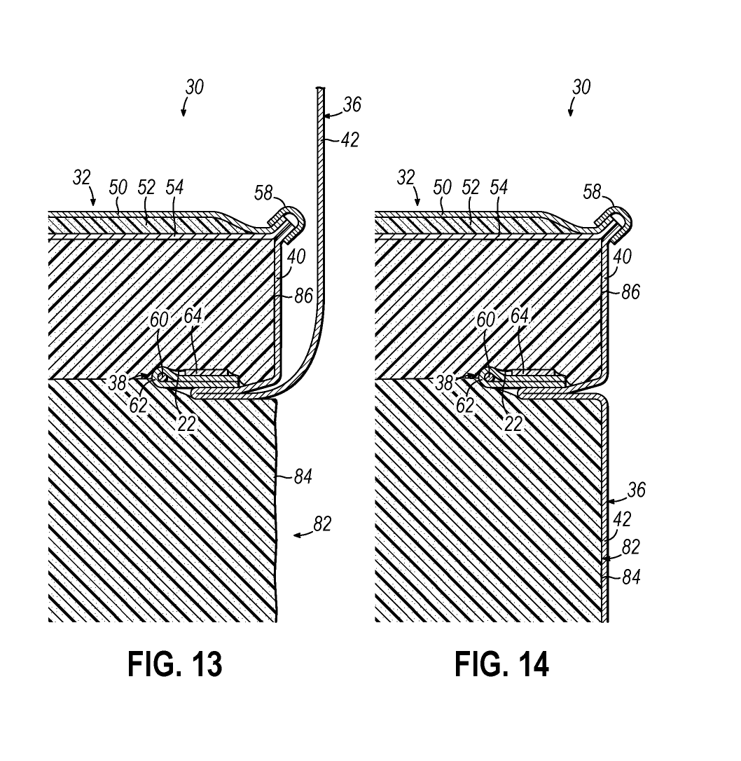

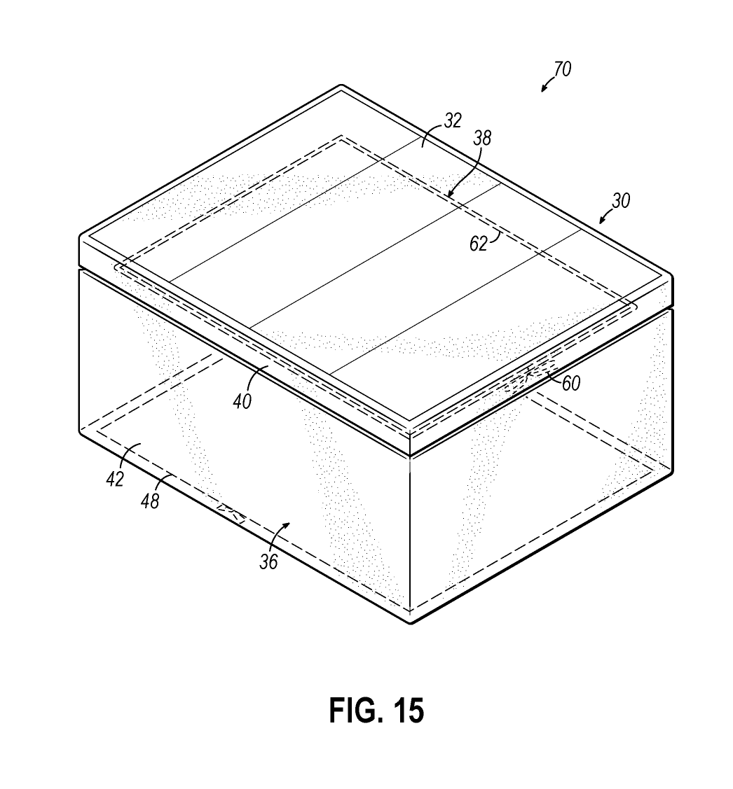

While in the embodiment shown in FIGS. 1-6 a foam encased inner spring core was utilized, a solid foam core could just as well be utilized. In addition, while in the embodiment shown in FIGS. 1-7, slit 22 is formed by a knife or blade to cut into the foam, the slit 22 could also be formed by bonding two layers of foam together as by gluing or the like, but leaving the confronting surfaces of the two layers of foam around their peripheries unbonded. To that end, an alternative embodiment of mattress core and cover assembly 80 is illustrated in FIGS. 8-15. With like numbers representing like elements, a solid foam core 82 is formed by adhering a first foam core section 84 and a second foam core section 86 together, except at their confronting peripheral surfaces, thereby forming slit 22.

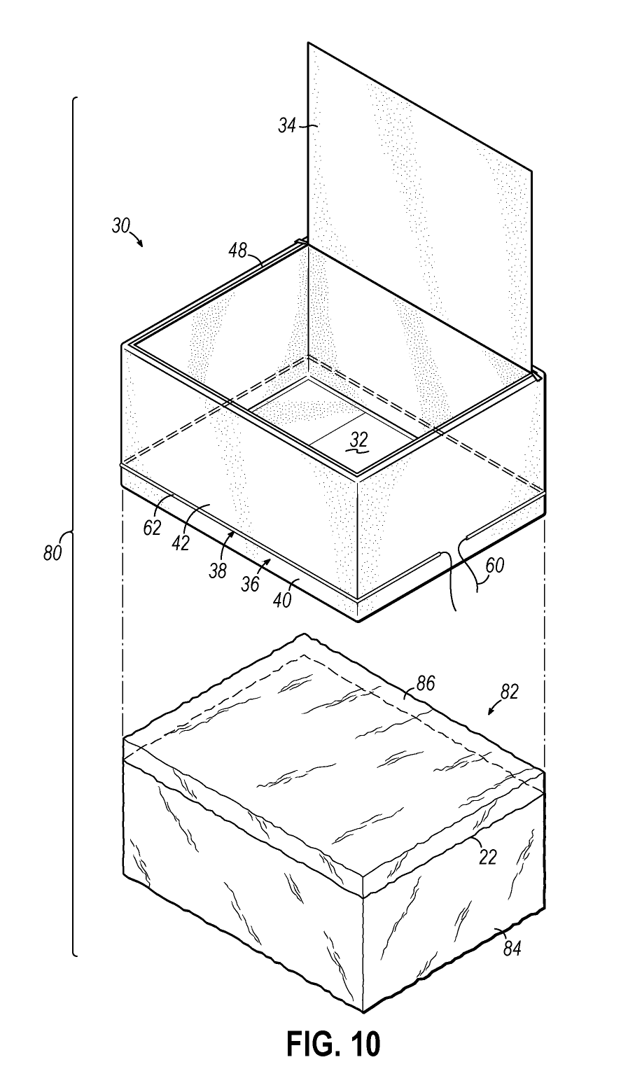

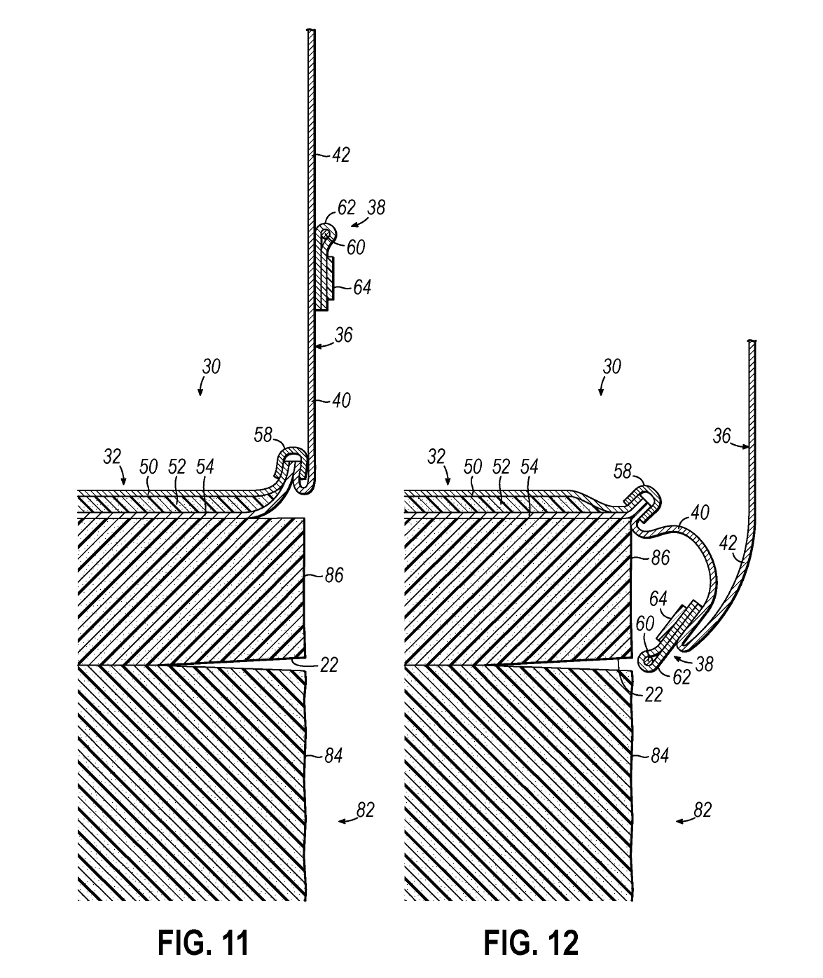

Assembly of the FIGS. 8-15 embodiment is the same as that described above in connection with the FIGS. 1-7 embodiment. The cover 30 is first inverted from the position shown in FIG. 10 and then turned inside out as is illustrated in FIGS. 11-14. The cover 30 is wrapped over the top of the mattress core 82 and the draw-cord 38 is tucked into the slit 22. The draw-cord 38 is then tightened pulling the material of the cover 30 into the slit 22. Then, the cover 30 is pulled down over the rest of the mattress core 82. Finally, the bottom panel 34 is secured to the border 36 by zipping the zipper 48 closed, thereby forming the mattress core and cover assembly 80.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. The invention resides in each individual feature described herein, alone, and in all combinations of any and all of those features. Accordingly, the scope of the invention shall be limited only by the following claims and their equivalents.

What is claimed is:

1. A cover for receiving and completely encasing therein a separate underlying core structure and for providing the appearance of multiple segments in the underlying core structure, the underlying core structure having a slit extending inwardly into and around the periphery of the core structure, the cover comprising:
a top panel configured to cover an upper surface of the core structure,
a bottom panel configured to cover a lower surface of the core structure,
a border connecting the top panel with the bottom panel and configured to cover the sidewalls of the core structure, and
a tucking element coupled with the border and configured to be moved peripherally inwardly of the periphery of the underlying core structure as the cover is wrapped around the underlying core structure so as to be received in the slit of the core structure, such that a portion of the border between the tucking element and the top panel appears to be a first segment of the core structure and a portion of the border between the tucking element and the bottom panel appears to be a second segment of the core structure.

2. The cover of claim 1, wherein the tucking element includes a cord.

3. The cover of claim 2, wherein the cord is selected from the group consisting of an elastic cord and a draw-cord.

4. The cover of claim 2, wherein the tucking element further includes a rigid band.

5. The cover of claim 4, wherein the cord includes a draw-cord.

6. The cover of claim 1, wherein the top panel is connected with the border by a binding joint.

7. The cover of claim 1, wherein the top panel includes a plurality of layers.

8. A method of receiving and completely encasing a separate core structure within a cover to create the appearance of multiple segments in the core structure, comprising:
positioning a top panel of the cover adjacent an upper surface of the core structure,
positioning a border of the cover adjacent the sidewalls of the core structure,
inserting a tucking element coupled with the border into a slit extending inwardly into and around the periphery of the core structure as the cover is wrapped around the core structure, and
positioning a bottom panel of the cover adjacent a lower surface of the core structure, such that a portion of the border between the tucking element and the top panel appears to be a first segment of the core structure and a portion of the border between the tucking element and the bottom panel appears to be a second segment of the core structure.

9. The method of claim 8, wherein the tucking element includes a cord, and further comprising:
moving the cord into the slit toward the interior of the core structure.

10. The method of claim 9, wherein the cord includes a draw-cord, and moving the cord includes tightening the draw-cord.

11. The method of claim 9, wherein the cord includes an elastic cord, and moving the cord includes allowing the elastic cord to retract.

12. The method of claim 8, further comprising:
closing the cover.

13. The method of claim 12, wherein closing the cover includes closing a zipper of the cover.

14. The method of claim 8, further comprising:
creating the slit in the core structure.

15. The method of claim 14, wherein creating the slit includes cutting the core structure.

16. The method of claim 14, wherein creating the slit includes forming the core structure by combining a first component and a second component so as to define the slit between the first component and the second component.

17. An assembly, comprising:
a core structure having an upper surface, a lower surface, sidewalls between the upper surface and the lower surface, and a slit extending inwardly in the sidewalls around the periphery of the core structure, and
a separate cover receiving and completely encasing therein the core structure, the cover including a top panel and a bottom panel interconnected with a border, the border having a peripherally inwardly extending tucking element, the top panel covering the upper surface, the bottom panel covering the lower surface, the border covering the sidewalls, and the tucking element received in the slit, wherein a portion of the border between the tucking element and the top panel appears to be a first segment of the core structure and a portion of the border between the tucking element and the bottom panel appears to be a second segment of the core structure.

18. The assembly of claim 17 wherein the core structure is a solid foam core.

19. The assembly of claim 17 wherein the core structure is a foam-encased inner spring core.
